(19) United States
(12) Patent Application Publication
(10) Pub. No.: US 2012/0223277 A1
(43) Pub. Date: Sep. 6, 2012

(54) SLIVER STRUCTURE AND METHOD OF HANDLING SLIVER STRUCTURES

(75) Inventors: Gurtej S. Sandhu, Boise, ID (US); Naga Chandrasekaran, Boise, ID (US)

(73) Assignee: MICRON TECHNOLOGY, INC., Boise, ID (US)

(21) Appl. No.: 13/038,091

(22) Filed: Mar. 1, 2011

(51) Int. Cl. H01B 1/02; C01B 19/04; H01B 1/22; C01B 17/00; H01B 1/10; C01B 33/02; C01B 19/00

(52) U.S. Cl. 252/519.34; 423/348; 423/509; 423/508; 423/511; 252/500; 252/519.4; 252/519.33; 428/220

(57) ABSTRACT

Methods for orienting a plurality of sliver structures include applying at least one directional force to a group of sliver structures each having an orientation material applied to an edge to cause the plurality of sliver structures to orient in a common direction. The method may also include capturing the oriented sliver structures in a capture device to maintain the orientation of the sliver structures in the common direction. The oriented sliver structures may be used to form sub-assemblies such as solar array sub-assemblies that are used to generate solar power. Methods of applying an orientation material to sliver structures and resulting sliver structures are also disclosed.

### TECHNICAL FIELD

Embodiments of the present disclosure relate to semiconductor structure fabrication processes and, more specifically, to handling and orienting slivers of semiconductor material from a bulk semiconductor substrate.

### BACKGROUND

In order to increase the usable surface area of material of a substrate of a semiconductor material such as silicon, a bulk semiconductor substrate such as a silicon wafer may be severed across and perpendicular to a major plane thereof to singulate thousands of smaller, thin, elongate structures having opposing major faces, one of both of which may then serve as an active surface.

Such thin, elongate structures are known by those of ordinary skill in the art as substrate slivers, elongate substrates, sliver substrates, substrate slivers, plank substrates, slivers, sliver structures, or merely slivers. Sliver structures are generally of a parallelepiped form and have a high aspect ratio in that a length of such a structure is typically substantially greater (in some cases tens to hundreds of times larger) than a height thereof. Further, a thickness of a sliver structure is typically four to one hundred times smaller than a height thereof. The length and height of a sliver structure define the dimensions of opposing major faces of the structure. The thickness or width of a sliver structure is the distance between opposing major faces of the sliver structure. A representative sliver structure may be about 10-120 mm long, about 0.5-5 mm high, and about 15-400 μm thick. Of course, these dimensions may vary depending on the intended application for the sliver structure and the type and dimensions of a bulk semiconductor substrate from which a sliver is severed.

One conventional use for sliver structures is as photovoltaic devices or solar cells assembled with a large number of other sliver structures to form a solar panel. Each sliver structure may be configured as a small solar cell also known as an elongate solar cell, solar sliver, solar sliver cell, or the like. Elongate solar cells can be produced by processes such as those described in “HighVo (High Voltage) Cell Concept” by S. Scheibenstock, S. Keller, P. Fath, G. Willeke and E. Bucher, Solar Energy Materials & Solar Cells Vol. 65 (2001), pages 179-184 (“Scheibenstock”), and in International Patent Application Publication No. WO 02/45143 (“the Sliver Patent”). The latter document describes processes for producing a large number of thin (generally <150 μm) elongate silicon substrates from a single conventional silicon wafer, where the dimensions of the major faces of resulting thin elongate substrates are such that their total surface area is far greater than a major surface of the original silicon wafer. Such elongate substrates are referred to in the Sliver Patent as “sliver substrates.” The Sliver Patent also describes processes for forming solar cells on sliver substrates, referred to as ‘sliver solar cells’. The word ‘sliver’ generally refers to a sliver substrate or sliver structure which may or may not incorporate one or more solar cells. The word “SLIVER” is a registered trade mark of Origin Energy Solar Pty Ltd, Australian Registration No. 933476.

In general, elongate solar cells can be single-crystal solar cells or multi-crystalline solar cells formed from elongate substrates. The elongate substrates are conventionally formed in a batch process by cutting a series of parallel elongate slots through a thickness of a silicon wafer to define a corresponding series of mutually parallel, thin elongate substrates separated from one another along their adjacent lengths and heights and joined together at their outer ends by the remaining portions of the wafer, referred to as the wafer frame. Solar cells can be formed from the elongate substrates while they remain in the wafer frame, and subsequently separated from each other and from the wafer frame to provide a set of individual elongate solar cells.

The elongate sliver structures from which elongate solar cells are formed are extremely fragile and, thus, require careful handling, in particular during separation from the host wafer, testing, sorting and binning, storage, mounting and electrical interconnection. Additionally, since the area of the major faces and power generation value of each elongate solar cell is extremely small when compared with the surface area of conventional (i.e., non-elongate, wafer- or other bulk semiconductor substrate-based) solar cells, there is a need for reliable, low cost handling, assembly, and mounting processes to foam a solar panel from large numbers (e.g., thousands or tens of thousands) of elongate solar cells in order to make use of the elongate solar cells formed from sliver structures economically viable. Existing approaches to using elongate solar cells to form photovoltaic devices have been limited in scope. Some applications have involved gluing the elongate solar cells to a substrate or a transparent or semi-transparent superstrate such as glass, to form a solar panel comprising an array of electrically connected elongate solar cells having major faces oriented upwardly to capture solar radiation. A “pick and place” robotic machine can be used to position individual elongate solar cells on the substrate or superstrate.

Conventional solar panel modules, particularly modules constructed using mono-crystalline or multicrystalline silicon wafers, typically contain around 60 to 70 wafer cells per square meter of module area. The wafer cells used in most conventional modules are mono-facial (i.e., they provide only one active surface exposed for illumination), and there is no difficulty identifying the correct orientation of the cells. The large (e.g., typically 4 inches) diameter of conventional wafer cells also means that there is virtually no likelihood of the cells being misoriented in the handling and assembly processes. The number of electrical connections in a module comprising conventional wafers is of the order of 200, or around 3 to 4 per cell.

With elongate solar cells, the number of electrical connections may be around six or eight per cell, but because the area of each elongate cell is only a small fraction of the area of a conventional wafer cell, the number of electrical connections for modules incorporating only elongate solar cells may be in the range of 2,000 to 20,000 or more per square meter of solar panel module area. Thus, a non-conventional approach is required in order to reliably and inexpensively establish inter-cell electrical interconnections of solar panel modules incorporating elongate solar cell sub-module assemblies.

Furthermore, the mono-facial nature of conventional cells allows their orientation and polarity to be easily determined visually. However, elongate solar cells can be bifacial (i.e., have two opposing optically active faces), and can also be perfectly symmetrical in physical appearance, making visual determination of their polarity impossible. Elongate solar cells, having a very large aspect ratio, can readily warp or bend if they are thin enough, but at the same time are quite brittle when subjected to localized stress and may fracture or become otherwise damaged during separation, handling, testing, binning, and assembly.

Another difficulty with elongate solar cells is that they can easily be mis-oriented about their horizontal (length) axes during separation and handling. The bifacial nature of some forms of elongate solar cell requires that the orientation, and hence the polarity, of each cell is maintained in an absolutely reliable manner during handling. Mis-oriented elongate bifacial solar cells can, if inadvertently be incorporated in the solar panel module in an orientation that forces them to operate in reverse bias, reduces the module power output and has the potential to destroy the cell and damage other cells of the solar panel module, which may render the module inoperable.

### BRIEF DESCRIPTION OF THE DRAWINGS

FIG. 1 is a top view of one embodiment of a semiconductor wafer having sliver structures formed therein;

FIG. 2 is a top view of one embodiment of the sliver structures as separated from the semiconductor wafer frame;

FIG. 3a is a perspective view of one embodiment of a sliver structures configured as an elongated solar cell in accordance with the present disclosure;

FIG. 3b is cross-sectional view across the sliver structures at lines A-A and B-B in FIG. 3a;

FIG. 4a is a perspective view of a plurality of sliver structures with an orientation material along one edge prior to orientation in accordance with the present disclosure;

FIG. 4b is a side view of one embodiment of applying a directional force to a plurality of sliver structures in accordance with the present disclosure;

FIG. 5a is a side view of one embodiment of applying a directional buoyancy force to a plurality of sliver structures in accordance with the present disclosure;

FIG. 5b is a side view of another embodiment of applying a directional buoyancy force to a plurality of sliver structures in accordance with the present disclosure;

FIG. 6a is a side view of one embodiment of applying a directional buoyancy force and a directional flow force to a plurality of sliver structures in accordance with the present disclosure;

FIG. 6b is a side view of another embodiment of applying a directional buoyancy force and a directional flow force to a plurality of sliver structures in accordance with the present disclosure;

FIG. 7a is a side view of another embodiment of applying a directional buoyancy force and a directional flow force to a plurality of sliver structures in accordance with the present disclosure;

FIG. 7b is a side view of one embodiment of applying a directional magnetic force to plurality of sliver structures in accordance with the present disclosure;

FIG. 8a is a top view of one embodiment of a capture device for capturing sliver structures in accordance with the present disclosure;

FIG. 8b is a perspective view of one embodiment of a portion of a capture device for capturing sliver structures in accordance with the present disclosure; and

FIG. 9 is a schematic flow chart illustrating one embodiment of a method of orienting substrate slivers in accordance with the present disclosure.

### DETAILED DESCRIPTION

In the following detailed description, reference is made to the accompanying drawings, which form a part hereof, and in which is shown, by way of illustration, specific embodiments in which the invention may be practiced. These embodiments are described in sufficient detail to enable a person of ordinary skill in the art to practice the invention. However, other embodiments may be utilized, and structural, logical, and electrical changes may be made without departing from the scope of the invention. The illustrations presented herein are not meant to be actual views of any particular device or system, but are merely idealized representations that are employed to describe embodiments of the present disclosure. The drawings presented herein are not necessarily drawn to scale. Additionally, elements common between drawings may retain the same or have similar numerical designation.

The following description provides specific details, such as material types, material thicknesses, and processing conditions in order to provide a thorough description of embodiments of the present disclosure. However, a person of ordinary skill in the art will understand that the embodiments of the present disclosure may be practiced without employing these specific details. Indeed, embodiments of the present disclosure may be practiced in conjunction with conventional fabrication techniques employed in the industry. Only those process acts and structures to facilitate an understanding of the embodiments of the present disclosure are described in detail below.

Reference herein to “one embodiment,” “an embodiment,” or similar language means that a particular feature, structure, or characteristic described in connection with the embodiment is included in at least one embodiment of the present disclosure. Thus, such phrases may, but do not necessarily, all refer to the same embodiment. Furthermore, it is contemplated that the described embodiments, features, structures, or characteristics of the disclosure may be combined in any suitable manner in one or more embodiments. Additionally, it should be recognized that the various embodiments may be practiced without one or more of the specific details, or with other methods, components, materials, and so forth. In some instances, well-known structures, materials, or operations are not shown or described in detail to avoid obscuring aspects of the disclosure.

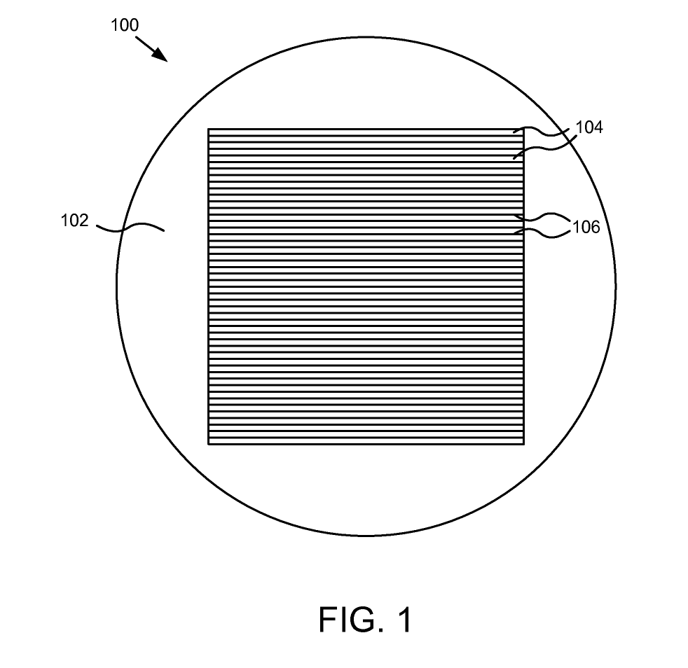

FIG. 1 is a top view of one embodiment of a semiconductor wafer 100 configured as a semiconductor wafer frame 102 with sliver structures 104 formed therein in accordance with the present disclosure. The depicted wafer frame 102 and sliver structures 104 are not drawn to scale but are provided to exemplify the formation of sliver structures 104 in a semiconductor wafer 100.

The semiconductor wafer 100 is typically single crystal silicon or multicrystalline silicon (or poly-crystalline silicon), but other types of semiconductor substrate materials are contemplated such as amorphous silicon, cadmium telluride, copper indium selenide/sulfide, or the like. Conventionally, the sliver structures 104 are formed from the wafer in a substantially parallel manner with respect to each other as depicted. However, other configurations and embodiments are contemplated such as wherein some sliver structures 104 are formed in parallel along a first axis in one portion of the wafer frame 102 and wherein other sliver structures are formed in parallel along a second direction that is orthogonal or obtuse with respect to the first axis. Various configurations and layouts of sliver structure formations may be used to increase the usable surface area of the semiconductor wafer frame 102.

The sliver structures 104 may be formed from the semiconductor wafer 100 by forming slots 106 into the semiconductor wafer 100. The formed slots 106 separate the semiconductor material into thin elongated strips that are attached at their respective ends to the semiconductor wafer frame 102. In one embodiment, the slots 106 may be formed by a saw such as a wafer dicing saw having a narrow, diamond-edged blade. In other embodiments, the slots 106 may be formed by other techniques such as laser ablation, a water-jet cutting system, or by using a wet anisotropic etchant, such as potassium hydroxide solution (KOH), as well as by other techniques known to one of ordinary skill in the art.

By forming the slots 106 into the wafer 100, a front major face and a rear major face are formed on each respective sliver structure 104. The height of the major faces typically corresponds to the thickness of the semiconductor wafer 100 from which they are formed, which is conventionally between about 0.3 mm and about 2 mm. Thus, for a semiconductor wafer with a thickness of about 0.5 mm, the height of a sliver structure 104 is similarly about 0.5 mm. However, the semiconductor wafer 100 may be formed using various thicknesses and dimensions, and the slots 106 may be formed at non-orthogonal angles to a planar surface of the substrate resulting in a height of the sliver structures 104 that may vary somewhat from the thickness of the semiconductor wafer 100. By forming the slots 106 into the semiconductor wafer to leave frame 102 as a support, a plurality of elongated semiconductor sliver structures 104 result from the remaining wafer material.

The slots 106 may be formed with varying widths and lengths depending on the desired dimensions of the resulting sliver structures 104. The width of the slots 106 may be minimized in order to reduce material losses from the slots between sliver structures 104, but minimum slot widths are limited by the cutting technique used to form the slots 106. In one embodiment, the slots 106 may be about 0.05 mm wide and the resulting thickness of the sliver structures 104 may be about 0.05 mm. However, the resulting thickness of the sliver structures 104 may vary depending on preference and intended application of the sliver structures 106. The length of the slots 106 corresponds to a desired length of the sliver structures 104 and the desired length may vary based on intended application of the sliver structures 104 and/or the dimensions of the semiconductor wafer 100. In at least one embodiment, the sliver structures 104 and corresponding slots 106 are formed with substantially equal lengths. Although various lengths are contemplated, a typical length of a sliver structure 104 is between about 40 mm and about 200 mm.

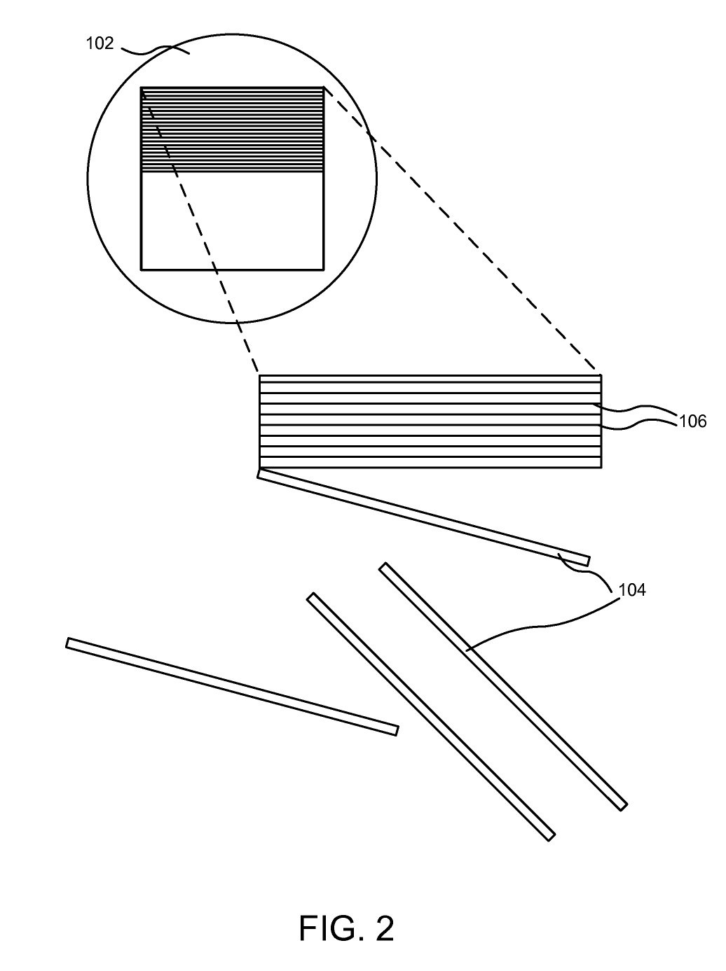

FIG. 2 is a top view of one embodiment of the sliver structures 104 as separated from the semiconductor wafer frame 102. Separation may be accomplished by detaching the ends of each sliver structure 104 from the semiconductor wafer frame 102. In one embodiment, detachment of the ends of each sliver structure 104 may be accomplished by applying a snapping force to the sliver structures 104 at ends thereof, by cutting the sliver structures 104 from the semiconductor wafer frame 102 using a saw or laser ablation, by etching away the ends of the sliver structures 104, or by any other means recognized by one of skill in the art. As noted previously, in certain applications, such as when the sliver structures 104 are configured as elongated solar cells, operation of the solar cells may depend on an orientation of the top portion of each sliver structure 104 with respect to a bottom portion of each sliver structure 104.

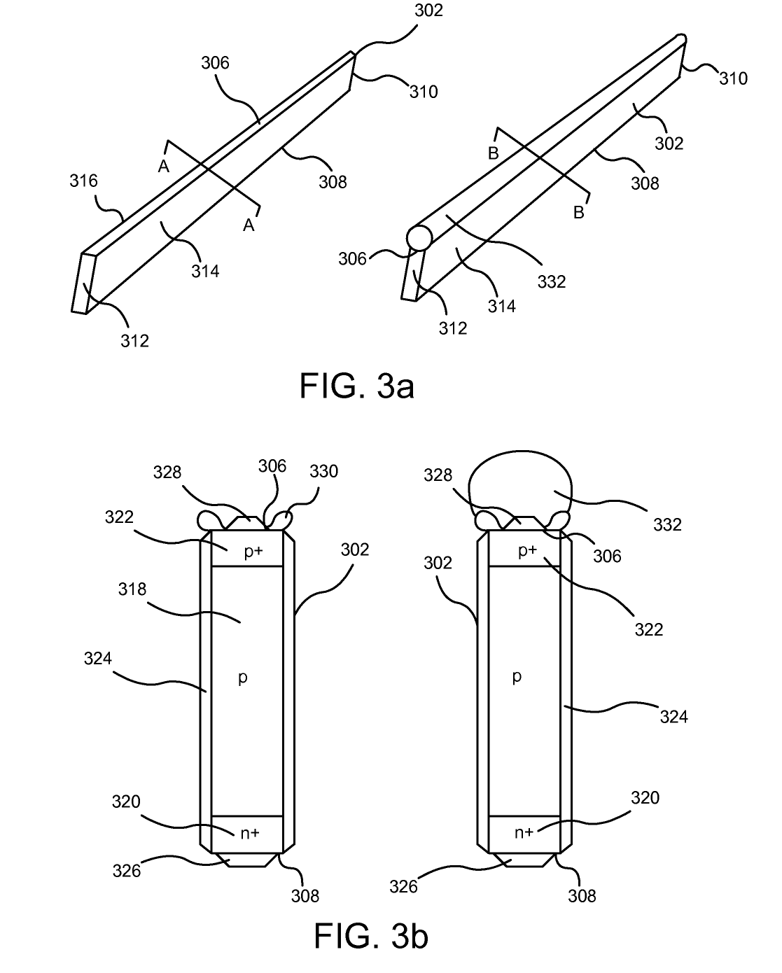

FIG. 3a is a perspective view of one embodiment of a sliver structure 302 at various processing acts in accordance with the present disclosure. As depicted, a sliver structure 302 is configured as an elongated solar cell. Another embodiment of a sliver structure 302 with an orientation material 332 added along one edge 306 is also depicted in FIG. 3a in accordance with the present disclosure. FIG. 3b is a cross-sectional view across the sliver structures 302 at lines A-A and B-B as seen in FIG. 3a.

The sliver structure 302 is a substantially elongated structure with a length that is typically much greater than its height or width. However, other sizes and shapes of the sliver structure 302 are contemplated herein. The sliver structure 302 has a first edge 306 (e.g., an elongate edge), which may also be referred to as an upper edge or top edge, and a second edge 308, (e.g., an elongate edge) which may also be referred to as a lower edge or bottom edge. In one embodiment, the first edge 306 and second edge 308 are elongated with the dimensions of the sliver structure 302. In one embodiment, the first edge 306 is formed from the top, major planar surface of the semiconductor wafer 100 as a result of forming the slots 106 into the semiconductor wafer 100. Similarly, the second edge 308 is formed from the bottom, opposing major planar surface of the semiconductor wafer 100. The sliver structure 302 may also have a first end edge 310 and a second end edge 312. A length of the first and second end edges 310, 312 define a height of the sliver structure 302 and corresponds to a distance between the first edge 306 and the second edge 308.

The sliver structure 302, as depicted, also has a first major face 314 and an opposing second major face 316. The first and second major faces 314, 316 are formed from the interior material of the semiconductor wafer when the slots 106 are formed into the semiconductor material. A material, such as an oxide, may coat the first and/or second major face 314, 316. The sliver structure 302 may be configured as a mono-facial or bi-facial solar cell. A mono-facial device is to be irradiated on only one major face 314 and a bi-facial solar cell is to be irradiated on both the first major face 314 and the second major face 316. In the depicted embodiment, the sliver structure 302 is configured as a bi-facial solar cell.

As noted, the sliver structure 302 is configured as a solar cell. A solar cell as used herein is a solid state device that converts the energy of sunlight or other light or energy sources into electricity by the photovoltaic effect. As seen in FIG. 3b, the sliver structure 302 has an interior body 318 formed of the semiconductor material of the semiconductor wafer 100. In one configuration, the body 318 is made of a lightly p-type doped material. As depicted, the sliver structure 302 includes an n+ region 320 near the bottom edge 308 of the sliver structure 302. In one embodiment, the n+ region is formed by a surface diffusion of n-type dopants made on the bottom surface of the semiconductor wafer 100 before slots 106 are formed. For example, the surface diffusion of n-type dopants may be a heavy phosphorus diffusion. The substrate sliver structure 302, as depicted, also includes a p+ region 322 near the top edge 306 of the substrate sliver structure 302. In one embodiment, a surface diffusion of p-type dopants is performed on the top surface of the semiconductor wafer 100 before slots 106 are formed to form the p+ region 322. For example, the surface diffusion of p-type dopants may be a heavy boron diffusion.

The sliver structure 302 may include an oxide wall 324 on one or both of the first and second faces 314, 316. A conductive material, such as a metal 326 may be located along the second edge 308 to provide an electrical path to the n+ region 320 of the sliver structure 302. Similarly, a conductive material, such as a metal 328 may be located along the first edge 306 to provide an electrical path to the p+ region 322 of the sliver structure 302. In one embodiment, a dielectric material 330 may be applied along one or more edges of the sliver structure 302. The dielectric material 330 may be configured to increase the efficiency of the solar cell configuration of the sliver structure 302. As will be recognized by one of skill in the art, other configurations and materials may be similarly used to configure the sliver structure 302 as an elongated solar cell.

As seen in FIGS. 3a and 3b, the sliver structure 302 is substantially symmetrical about a vertical axis. The right side and left side of the sliver structure 302 are essentially mirror images of one another. However, the sliver structure 302 is not symmetrical about a horizontal axis. The first edge and second edge are different in structure and function and must be oriented properly in solar cell applications. Due to the minute size of a sliver structure 302, it is not practical to attempt to distinguish the first edge 306 from the second edge 308 with the naked eye. Therefore, in one embodiment (FIG. 3b), a sliver structure 302 is provided with an orientation material 332 applied along the first edges 306 to distinguish the first edge 306 from the second edge 308.

The orientation material 332 may be a material such as a polymer or other type of flowable material that may be used to form a head on the elongated edge 306 to which it is applied. As seen in FIG. 3b, the head of orientation material 332 may have a rounded shape resulting from a flow or other deposition process using a flowable material, and a meniscus effect. However, other shapes and designs such as square, rectangular, or triangular heads are also contemplated herein. The size and shape of the head may be determined by at least one of flow rate, viscosity and surface tension of the orientation material 332 in one embodiment or the head may be sized and shaped using processes such as etching or molding to create a desired head shape.

In one embodiment, the orientation material 332 may be a heat sensitive, thermoplastic material that can be melted and hardened. In a further embodiment, the orientation material 332 may be selected to have a relatively low melting point above ambient temperature, or be formulated to cure at ambient temperature. Ambient temperature, as the term is used herein may range from about 15° C. to about 35° C. As depicted, the orientation material 332 is applied to the edge 306 of the sliver structure 302 associated with the p+ region 322. However, the orientation material 322 may be applied to either edge 306, 308 to distinguish it from the opposite edge 306, 308.

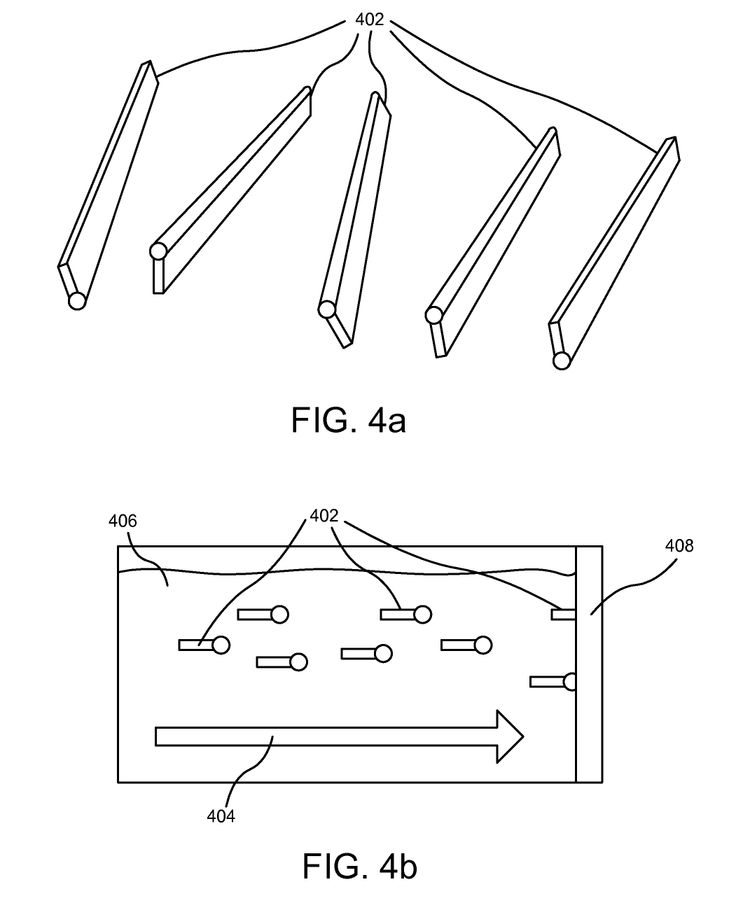

As noted above, a head formed of orientation material 332 may be used to visually distinguish the first edge 306 from the second edge 308 of the sliver structure 302. The orientation material 332 may also be used to orient the sliver structure 302 in response to an applied directional force. For example, the sliver structure 302 may be placed in a liquid medium in which sliver structures 302 will float and a buoyancy force provided by the liquid medium may cause sliver structures 302 to self-orient in a predetermined direction. The liquid medium may comprise, for example, water or another fluid medium of a suitable density and which would not contaminate the sliver structures 302. In one embodiment, the orientation material 332 may be selected to be of a lower density than the semiconductor material of the sliver structure 302, such that the orientation material 332 floats in the liquid medium and such that the denser sliver structure 302 hangs below the floating orientation material 332. The floating orientation material 332 may cause the sliver structure 302 to orient so that the second edge 308 opposite the orientation material 332 hangs vertically below the first edge 306 in the liquid medium. In another embodiment, the orientation material 332 may be of a higher density than the semiconductor material of the sliver structure 302 and, thus, may cause the sliver structure 302 to orient with the orientation material 332 and the first edge 306 hanging vertically below the second edge 308 in the liquid medium. In another embodiment, the liquid medium may be flowing within, for example, a channel and provide a force that has a “kite effect” on a sliver structure 302 and causes it to orient in a particular direction, due to the presence of the orientation material 332, within the liquid medium flow. For example, a plurality of sliver structures 302 with orientation material 332 along an edge 306 may be placed in a flowing liquid medium, and the force of the flowing liquid may act on the sliver structures to cause the sliver structures 302 to orient in a common direction. Orientation of the sliver structures 302 in a common direction ensures that polarity of the sliver structures 302 is arranged in a known, common direction for each of the sliver structures 302. In one embodiment, a combined buoyancy force and liquid flow force may be used to orient sliver structures 302 to ensure a desired orientation and to transport the sliver structures 302 toward a capture device for receiving the sliver structures 302 in the desired orientation and maintain such orientation for further processing. Descriptions of these and other orientation techniques are described below with regard to FIGS. 4a-7b.

In one embodiment, the orientation material 332 may be a conductive material such as a conductive polymer, so that a conductive electrical path is provided to the metal 328 applied to the first edge 306 of the sliver structure 302 when the sliver structure 302 is assembled with others to form a solar panel. In another embodiment, the orientation material 332 may be removed such as by vaporization or etching to provide a path to the metal 328 so that an electrical connection may be made directly to the metal 328. In one embodiment, only a portion of the orientation material is removed to provide access to the metal 328. The orientation material 332 may also be selected or formulated of a material which will bond, for example under application of heat or ultrasonic energy, to a substrate or circuit panel used to form larger sub-arrays from the sliver structures 302.

In one embodiment, the orientation material 332 creates an effective asymmetry about the horizontal (length) axis of the sliver structure 302. The effective asymmetry may be a spatial asymmetry, a mass or density asymmetry, a magnetic or electrical asymmetry, or other type of effective asymmetry that may facilitate orienting the sliver structure 302 in response to an applied force. For example, the orientation material 332 may be applied to form spatial asymmetry such that the orientation material 332 extends spatially from the edge 306 to which it is applied. The spatial asymmetry may be responsive to a liquid flowing past the orientation material 332 to cause the sliver structure 302 to orient accordingly. When the directional force of the liquid medium is applied to sliver structures 302 so configured, they may orient in a common direction. Similarly, a mass or density asymmetry may cause one edge 306 or 308 of the sliver structure 302 to be more buoyant than the opposing edge 306, 308. A magnetic or electrical asymmetry may be used to cause the sliver structure 302 formed of a suitable orientation material 332 to automatically align with adjacent, applied magnetic or electrical field lines.

The orientation material 332 may be applied to an edge 306, 308 of the substrate sliver structure 302 using techniques known in the art. For example, the orientation material 332 may be applied using a spin coat application, flow deposition, chemical vapor deposition, plasma enhanced chemical vapor deposition, physical vapor deposition, or other technique. In one embodiment, the orientation material 332 may be applied to the sliver structure 302 and etched back leaving a head portion along the elongated edge 306, 308. The orientation material 332 may be further etched to form a desired shape or spatial asymmetry. In one embodiment, the orientation material 332 is applied to the substrate sliver structures 302 while sliver structures 302 are still attached to the semiconductor frame 102 and after the slots 106 have been formed. However, the orientation material 332 may be applied before the slots 106 have been formed, where a cutting or etching technique is used to leave a portion of the orientation material 332 along the edge 306, 308 of each substrate sliver structure 302 when the slots 106 are formed. It is also contemplated that the orientation material may be applied after the sliver structures 302 have been fully or partially detached from the semiconductor wafer frame 102.

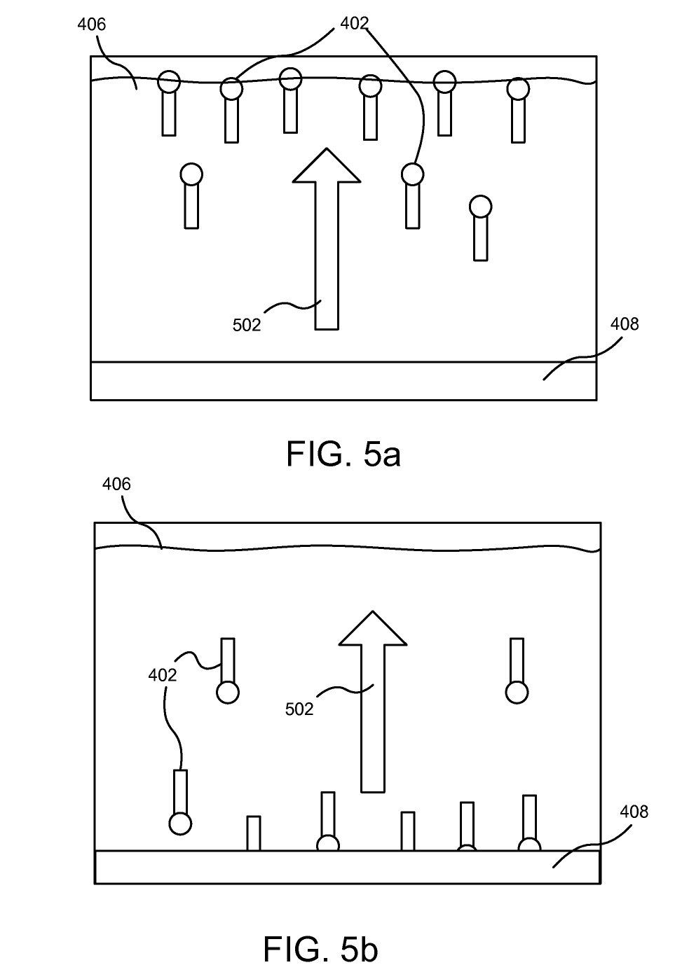

FIG. 4a is a perspective view of a plurality of sliver structures 402 with an orientation material 332 along one edge 306, 308 prior to orientation in accordance with the present disclosure. Once detached from the semiconductor frame 102, the plurality of sliver structures 402 may become disorientated with respect to one another and may be independently oriented along a plurality of different axes. FIGS. 4b, 5a, and 5b depict several embodiments for orienting the plurality of sliver structures 402 in a common direction. Generally, a directional force is applied to the plurality of substrate sliver structures 402, and the directional force acts on an asymmetry provided by the orientation material 332 to cause the plurality of sliver structures 402 to orient in the common direction. Once the sliver structures 402 are oriented in the common direction, they may be handled in a group fashion instead of one at a time. The sliver structures 402 can then be transferred to a substrate to form sub-arrays or larger arrays such as those used in solar cell assemblies. The oriented sliver structures 402 may, alternatively, be used in other applications as recognized by those of skill in the art.

FIG. 4b is a side view of one embodiment of applying a directional force 404 to a plurality of sliver structures 402 in accordance with the present disclosure. In the depicted embodiment, the sliver structures 402 are suspended in a liquid medium 406 and a directional force 404 is generated by a flow of the liquid in a particular direction. The directional force 404 caused by the liquid flow acts on the asymmetry of the sliver structures 402 provided by the orientation material 332 to cause each of the sliver structures 402 to orient in a common direction. Simultaneously, the directional force 404, causes the sliver structures 402 to travel in a direction toward a capture device 408 that is configured to capture the individual sliver structures 402 as oriented by the directional force 404. A directional force, in one embodiment, may have a kite effect on the orientation material 332 causing the sliver structures 402 to travel and orient in the common direction.

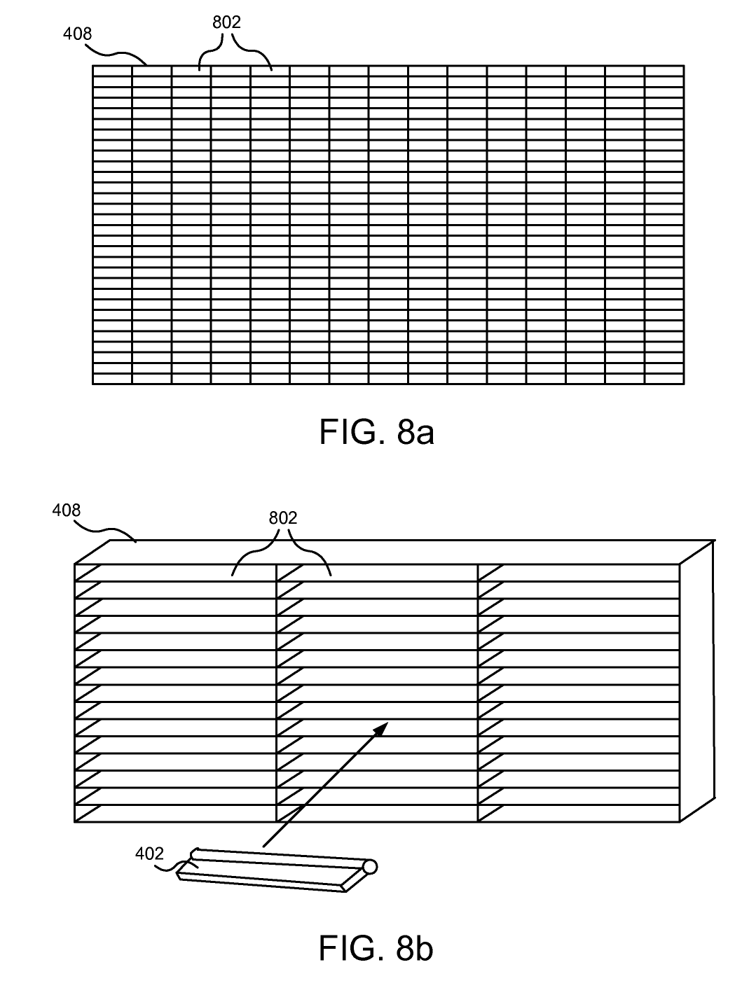

In one embodiment, the capture device 408 may be configured as a grid or mesh type structure with a plurality of capture slots arranged, for example, in a matrix of rows and columns formed therein (See FIGS. 8a and 8b). Each capture slot may be sized and configured to capture a single sliver structure 402 and maintain its orientation in the common direction. The sides of the liquid medium container may be configured to guide the sliver structures 402 toward the capture device 408 while maintaining the common directional orientation of the sliver structures 402. Once captured in the capture device 408, the plurality of sliver structures 402 may be transported in bulk fashion within the capture device 408 while maintaining the common orientation of the sliver structures 402.

FIG. 5a is a side view of one embodiment of applying a directional buoyancy force 502 to a plurality of sliver structures 402 in accordance with the present disclosure. As depicted, the sliver structures 402 are placed in a liquid medium 406. The buoyancy force 502 acts on the orientation material 332 of each sliver structure 402 to orient the sliver structures 402 in a common direction. In one embodiment, the orientation material 332 is less dense, and therefore more buoyant, than the rest of the sliver structure 402. Thus, the orientation material 332 floats toward the surface of the liquid medium 406, whereas the rest of the sliver structure 402 hangs down vertically into the liquid medium 406 with a common orientation. The density of the liquid used for the liquid medium 406 and the density of the orientation material 332 may be selected to preferentially float the orientation material 332 to the surface of the liquid medium 406 in the manner depicted.

In such an embodiment, the capture device 408 may be raised within the liquid medium from below the sliver structures 402 in a container holding the liquid medium to capture the sliver structures 402 in the device while maintaining the common vertical orientation. Alternatively, the capture device 408 may be located above the sliver structures 402 such that the sliver structures 402 float up into receiving slots of the capture device 408. Vibration may be applied to the capture device or through the liquid medium to cause the sliver structures 402 to settle into the receiving slots of the capture device 408.

FIG. 5b is a side view of another embodiment of applying a directional buoyancy force 502 to a plurality of sliver structures 402 in accordance with the present disclosure. In the depicted embodiment, the density of the liquid in the liquid medium 406 with respect to the density of the orientation material 332 and of the semiconductor material of the sliver structures is selected such that the sliver structures 402 sink to the bottom of a container holding the liquid medium 406. The orientation material 332 on the edge 306 of the sliver structures 402 causes the sliver structures 402 to sink with the orientation material 332 downward and the rest of the sliver structures 402 floating vertically upward. This causes each of the sliver structures 402 to orient in a common direction.

The capture device 408 may be placed at the bottom of container for the liquid medium 406 and slots of the capture device 408 may be configured to receive the sliver structures 402 as they sink, and maintain the sliver structures 402 in the common orientation. Again, a vibration or similar effect applied to the receiving device 408, to the container or to the liquid medium may be used to help the sliver structures 402 settle into the capture device 408. Of course, use of an orientation material 332 with a greater density than that of the semiconductor material of a sliver structure 402 but not so great as to cause sliver structures 402 to sink. In such an instance, the sliver structures 402 would float to the surface, buoyed by the liquid medium, but with orientation material 332 at the bottoms thereof, for receipt in a capture device 408 at the surface of the liquid medium or raised from the bottom of a container holding the liquid medium.

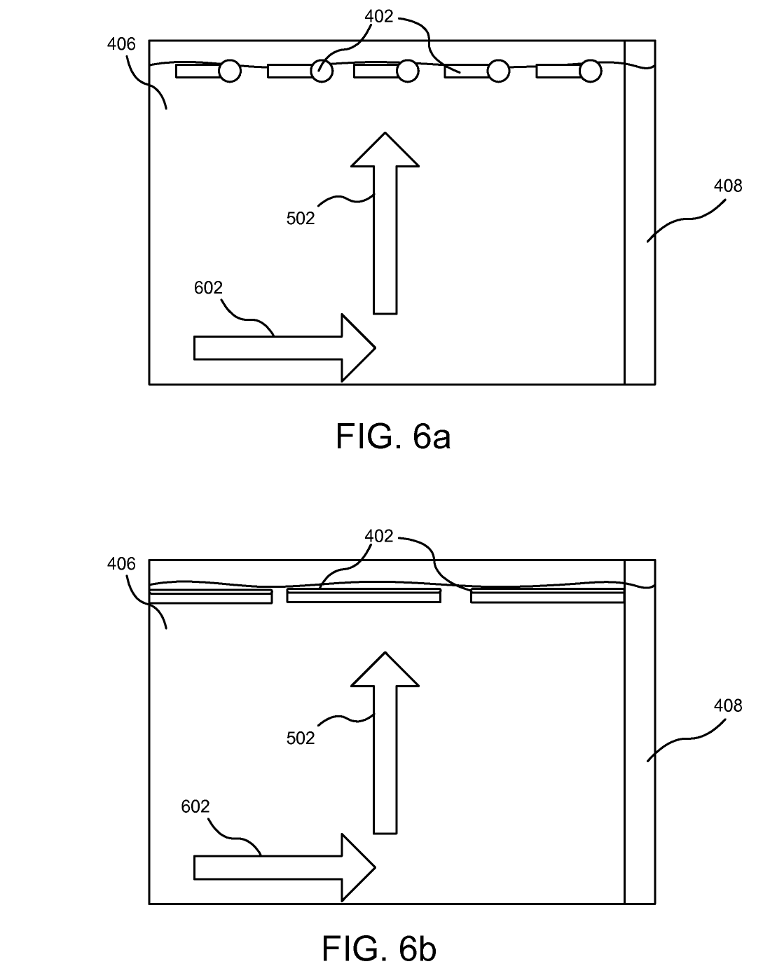

FIG. 6a is a side view of one embodiment of applying a directional buoyancy force 502 and a directional flow force 602 to a plurality of sliver structures 402 in accordance with the present disclosure. As depicted, the directional buoyancy force 502 causes each of the plurality of sliver structures 402 to float to the top of the liquid medium 406. The directional flow force 602 resulting from a flow of the liquid medium 406 acts on the orientation material 332 of each sliver structure 402 and causes each of the plurality of sliver structures 402 to orient in a common direction, for example parallel to a surface of the liquid medium and with orientation material headed in the direction of directional flow force 602. In such an embodiment, the density of the orientation material may be substantially the same as that of the semiconductor material of the sliver structures 402, but configured as, for example, an enlarged head in order to respond to the directional flow force 602 and rotate the sliver structures 402 so that orientation material faces forward in the direction of fluid flow. The directional flow force 602 may also cause the sliver structures 402 to travel toward the capture device 408 where the sliver structures 402 are captured. In one embodiment, the capture device 408 may be configured to move vertically upward or laterally transverse to the direction of fluid flow in conveyor fashion so that as slots in the capture device 408 fill with sliver structures 402, capture device 408 moves to align additional empty slots with the incoming sliver structures 402.

FIG. 6b is a side view of another embodiment of applying a directional buoyancy force 502 and a directional flow force 602 to a plurality of sliver structures 402 in accordance with the present disclosure. As depicted, the directional buoyancy force 502 again causes each of the plurality of sliver structures 402 to float to the top of the liquid medium 406 and to orient in a common direction with the orientation material 332, of a lower density than the semiconductor material of sliver structures 402 at the top edges and the rest of the sliver structures 402 hanging vertically below. In this embodiment, the directional flow force 602 resulting from a flow of the liquid medium 406 acts on the sliver structures 402 and causes each of the plurality of sliver structures 402 to travel toward the capture device 408 in the same direction with the horizontal longitudinal axes of the sliver structures 402 oriented parallel to directional flow force 602. The directional flow force 602 may also cause the sliver structures 402 to travel toward the capture device 408 where the sliver structures 402 are captured. The capture device 408 may be configured to move in conveyor fashion vertically upward or laterally transverse to the direction of fluid flow so that as slots in the capture device 408 fill with sliver structures 402 as they move along the surface of the liquid medium 406. The capture device 408 may move to align additional empty slots with the incoming sliver structures 402. In such an embodiment, the slots of capture device 408 may be further configured to receive the sliver structures 402 in their longitudinal orientation. In the embodiment of FIG. 6b, it is also contemplated that the orientation material 332 may be applied asymmetrically to an edge 306, 308 of sliver structures 402 with a head of increased dimension, which may also be characterized as a nose, at one end of each sliver structure 402 if, for example, if opposing major faces of each sliver structure differ and it is desirable to have similarly configured or treated major faces of all slivers 402 facing in the same direction for capture. Thus, the presence of the head provides a rotational orientation capability about a vertical axis responsive to contact with the flowing fluid medium.

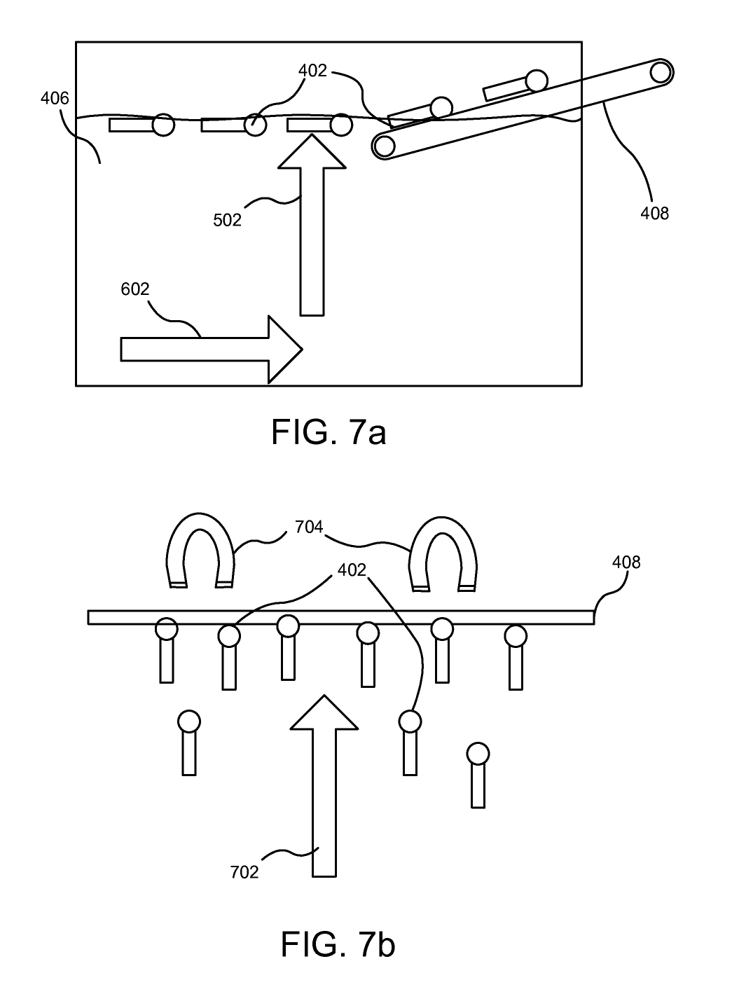

FIG. 7a is a side view of another embodiment of applying a directional buoyancy force 502 and a directional flow force 602 to a plurality of sliver structures 402 in accordance with the present disclosure. The embodiment depicted in FIG. 7a is similar to that depicted in FIG. 6a except that the capture device 408 is an angled conveyor type device that transports the sliver structures 402 from the liquid medium 406 as the sliver structures 402 flow toward and onto the conveyor device 408. The speed of the conveyor belt of capture device 408 may be preferentially adjusted to modify the spacing between the sliver structures 402 on the conveyor device. As the sliver structures 402 are transported by the conveyor device 408, the common orientation of the sliver structures 402 is maintained. In one embodiment, the conveyor device 408 may include slots, baffles or other mechanisms for receiving the sliver structures 402 therein and further maintaining the sliver structures 402 as oriented in the common direction and provide a substantially uniform spacing for the sliver structures 402 on the capture device 408.

FIG. 7b is a side view of one embodiment employing a directional magnetic force 702 to plurality of sliver structures 402 in accordance with the present disclosure. In the depicted embodiment, the orientation material 332 is a material that is responsive to a magnetic or electrical, field. In one embodiment, the field is generated by one or more magnetic devices 704 which may, for example, comprise electromagnets. The magnetic force 702 acts on the orientation material 332 to orient each of the sliver structures 402 in a common direction. In the depicted embodiment, the magnetic force 702 attracts the orientation material 332 upward toward the magnetic devices 704 as situated above the sliver structures 402. The capture device 408 may itself be magnetized by the magnetic devices 704 and may retain the sliver structures 402 magnetically therein. The capture device 408 receives the oriented sliver structures 402 and maintains them in the common orientation direction. In one embodiment, the edge 308 of the sliver structures 402 opposite the edge 306 with the orientation material 332, may be less reactive to the magnetic force 702 such that the opposite edge 306 hangs from below the capture device 408, or may exhibit a polarity opposite that of orientation material 332 so as to be repelled by magnetic force 702. Similar devices may be used for electric fields and devices. Use of a magnetic or electrical field-sensitive orientation material may also enable the operator to track the flow volume of sliver structures 302

In further embodiments, the magnetic force 702 may be used to simply align the sliver structures 402 in a common direction such as on a flat surface without lifting or substantially attracting the sliver structures 402 toward the magnetic devices 704. Once aligned in a common direction, a capture device 408 may be used to capture the sliver structures 402 and maintain them in the common direction. Similarly, the magnetic force 702 may be located and oriented to act on the sliver structures 402 as they are suspended in a liquid medium 406. Thus, once oriented in the magnetic field, a capture device 408 may be used to capture the sliver structures 402 in a manner such as is described above with regard to other liquid medium embodiments.

FIG. 8a is a top view of an embodiment of a capture device 408 for capturing sliver structures 402 in accordance with the present disclosure. FIG. 8b is a perspective view of a portion of the capture device 408. In the depicted embodiment, the capture device 408 includes a grid of receiving slots 802, which may also be characterized as capture slots 802, each configured to receive and retain sliver structure 402 therein. The capture slots 802 may be arranged in a various preferential patterns with a predetermined spacing and alignment. As depicted, the capture slots 802 are configured in an array with a plurality of vertical columns of capture slots 802 and a plurality of horizontal rows of capture slots 802. The dimensions of the capture slots 802 may be configured to correspond to the dimensions of a sliver structure 402 such that the capture slots 802 each retain a single sliver structure 402. In some embodiments, the capture slots 802 may be configured to retain more than one sliver structure 402 in a capture slot 802.

The capture device 408 may be formed of substantially rigid material. In one embodiment, the capture device 408 may be formed as a precursor structure and of a material or materials suitable for a solar sub-assembly or a solar array. For example, the capture device may be formed of or coated with a dielectric material resistant to electrostatic discharge (ESD). The capture device 408 may, further, be configured with circuit traces extending to terminal pads on end walls of each capture slot 802 to facilitate electrical connections between the various sliver structures 402 and ultimately to a circuit to which the array or sub-array of sliver structures 402 is to be connected.

As depicted in FIG. 8b, the capture device 408 has a depth from front to back that is used to house and align the sliver structures 402. However, the capture device 408 may be configured without a substantial depth or as a housing. For example, the capture device 408 may be configured as a wire-like grid. In such an embodiment, the heads of orientation material 332 on the sliver structures 402 may act to help retain the sliver structures 402 in the grid and to prevent the sliver structures from passing there through. In such an embodiment, the wire may be used as conductors for a solar panel assembly. In some embodiments, the capture device 408, or a channel in which the sliver structures move toward a capture device 408, may be configured with baffle or weir-type structures to direct sliver structures 402 moving in a fluid medium into the capture slots 802. In further embodiments, the capture device 408 may include capture slots 802 that are angled at a preferential, predefined angle other than transverse to the capture devise 408 to retain the sliver structures 402 commonly oriented at the preferential angle. For example, use of a preferential acute angle such as 45° may help facilitate placing the sliver structures 402 onto another substrate material such as a supporting substrate or glass superstrate as used in fanning solar arrays.

In one embodiment, the capture device 408 may include a plurality of capture slots 802 that are configured at a predetermined spacing in a predetermined pattern that corresponds to a preferential spacing pattern on a substrate of a higher-level structure, for example a solar array substrate. For example, when transferring sliver structures 402 configured as elongate solar cells to a substrate for assembly of a solar array, the sliver structures 402 may be spaced in a predefined pattern to align with electrical connections on, or to be made with, the substrate and in a spacing and orientation to provide improved irradiation of the elongated solar cells. Thus, the slots 802 of the capture device 408 may be configured to match a pattern of electrical connections on the substrate and/or to provide a preferential spacing and alignment of the sliver structures 402. In this manner, a plurality of sliver structures 402 may be transferred directly to a solar array substrate without the need for substantial additional reconfiguring, spacing, and aligning of the sliver structures 402.

In at least one example, the capture device 408 may itself be placed on the solar array substrate and may become a part of a solar array assembly or sub-assembly. In some embodiments, an additional transfer mechanism may be used to transfer the sliver structures 402 from the capture device 408 to a substrate while maintaining the common orientation of the sliver structures 402. For example, an adhesive device such as a wax plate may be used to adhesively attach the pre-aligned, pre-spaced sliver structures 402 from the capture device 408 and transfer them to a substrate for assembly or testing. Such an approach is disclosed and claimed in co-pending U.S. Patent Application Serial No. [DOCKET NO. 2269-10145US], filed on even date herewith and assigned to the Assignee of the present invention.

In further embodiments of the capture device 408, the capture slots 802 may be configured to receive the sliver structures 402 longitudinally with one of the short edges 310, 312 entering the capture slot 802. In other embodiments, the capture slots 802 may lack cellular divisions and may instead be implemented as a full row or full column opening without dividers between the cells. In yet a further embodiment, the capture device 408, may have no cells at all but may be a device such as a magnetic plat with magnetic segments that are spaced to each attract a magnetic orientation material 332 of a sliver structure 402 in a preferential spacing and orientation. As noted above, capture device 408 may also be configured to act in accordance with a vibration or similar rhythmic force such as sound waves or other energy waves to help settle the sliver structures 402 into corresponding capture slots 802 of the capture device 408. For example, in a liquid flow embodiment such is depicted in FIG. 4b, the sliver structures 402 may not align precisely with capture slots 802 of the capture device 408, so a vibration or other, slight repetitive movement of the capture device may act to facilitate proper alignment of the sliver structures 402 with a capture slot 802. In further embodiments, the capture device 408 be configured or supported by a drive mechanism to move up or down, from side to side, or both as rows of the capture device 408 are filled with sliver structures 408. Similarly, the capture device 408 may be incorporated as part of a conveyor type structure that continuously rotates rows of capture slots 408 or other structures such as recesses or baffles into position to receive sliver structures 402 therein.

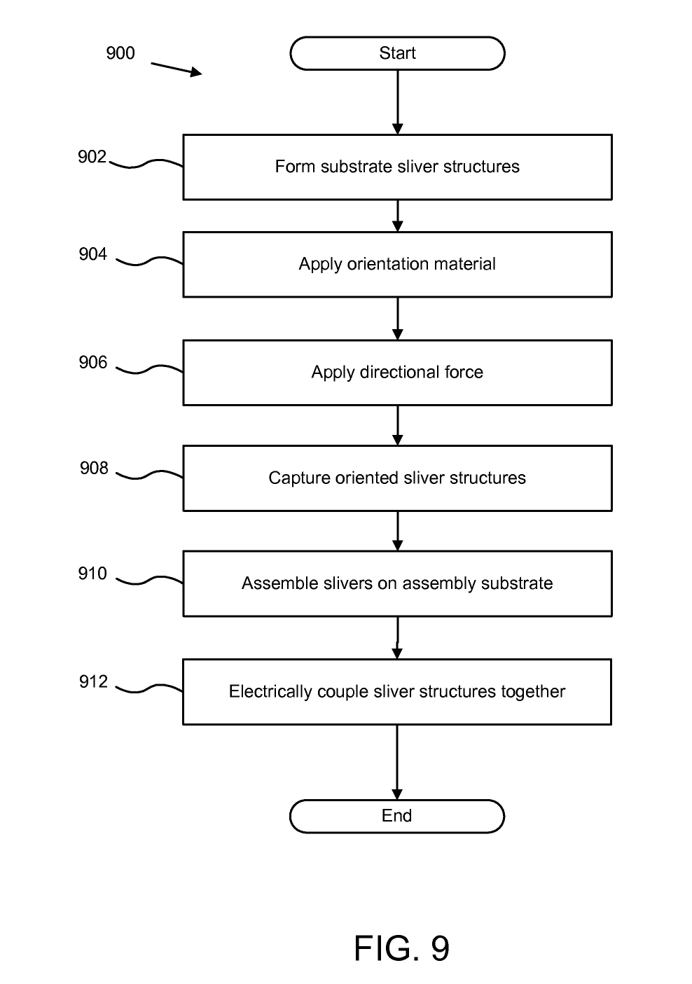

FIG. 9 is a schematic flow chart diagram illustrating one embodiment of a method 900 of orienting substrate slivers 402 in accordance with the present disclosure. It will be recognized that, in some embodiments, the method 900 may be performed without each of the depicted acts and, in other embodiments, may include additional acts not depicted herein. One of skill in the art will recognize that one or more of the acts may be performed simultaneously or in a different order than depicted.

In the depicted embodiment, the method 900 includes forming 902 substrate sliver structures 402. This may be done by creating slots 106 in a semiconductor wafer 100 or other semiconductor material as will be recognized by one of ordinary skill in the art. As described above with regard to FIG. 3, the sliver structures 402 may be configured as elongated solar cells. The sliver structures 402 may each have a first elongated edge 306 and a second elongated edge 308 with a front face 314 and a rear face disposed there between.

An orientation material 332 is applied 904 to one of the elongated edges 306, 308. The orientation material may be applied before or after sliver structures 402 are formed. The orientation material 332 may be configured to create an asymmetry such as a spatial, magnetic, or density asymmetry between the first and second edges 306, 308 of the sliver structures 402 to facilitate orientation of the sliver structures 402. A directional force 502 is applied 906 to the sliver structures 402 to orient each sliver structure 402 in a common direction. The asymmetry caused by the orientation material 332 reacts to the direction force 502 to orient the respective sliver structures 402 in the common direction.

The oriented sliver structures 402 are captured 908 in a capture device 408. The capture device 408 maintains the sliver structures 402 in their common orientation and, in some cases, enables transferring of and maintaining of spacing between the captured sliver structures 408. The substrate sliver structures 402 may be assembled 910 on an assembly substrate. In various embodiments, the orientation material 332 may be removed from the sliver structures 402 or incorporated into a sub-assembly design. The substrate sliver structures 402 may be electrically coupled 912 to form a sub-assembly of a solar array. As light or another energy source irradiates the faces 114, 116 of the sliver structures of the solar array, electricity may be generated by each individual sliver structure 402, and by the solar array as a whole.

### Conclusion

In one embodiment, the present disclosure comprises a method of handling sliver structures including applying at least one directional force to a plurality of sliver structures each having an orientation material applied to an edge thereof to cause the plurality of sliver structures to orient in a common direction.

In a further embodiment, a method of handling sliver structures includes forming a plurality of sliver structures in a bulk semiconductor substrate, each sliver structure having a first edge and a second edge opposite the first edge. The method may also include applying an orientation material onto the first or second edge of each sliver structure. The orientation material creates an increased asymmetry about a horizontal axis extending between the first elongated edge and the second elongated edge. The method may also include detaching the plurality of sliver structures from the bulk semiconductor substrate and applying a directional force to the plurality of sliver structures to orient the plurality of sliver structures in a common direction responsive to the asymmetry created by the orientation material.

In yet another embodiment, a method of forming sliver structures includes forming a plurality of sliver structures in a substrate material, and applying an orientation material onto an edge of each sliver structure.

One embodiment of a sliver structure is disclosed that includes an elongated body comprising a substrate material having a first edge and a second edge opposite the first edge, and an orientation material applied along at least a portion of the first edge of the elongated body.

While the invention is susceptible to various modifications and alternative forms, specific embodiments have been shown by way of example in the drawings and have been described in detail herein. However, the invention is not intended to be limited to the particular forms disclosed. Rather, the invention is to cover all modifications, equivalents, and alternatives falling within the scope of the invention as defined by the following appended claims and their legal equivalents.

What is claimed is:

1. A method of handling sliver structures, the method comprising:
applying at least one directional force to a sliver structure comprising a semiconductor material, the sliver structure bearing an orientation material on an edge thereof, to cause the sliver structure to orient in a desired direction.

2. The method of claim 1, further comprising depositing the sliver structure in a liquid medium, and wherein applying the directional force comprises generating a directional flow of the liquid medium.

3. The method of claim 1, wherein applying the at least one directional force comprises depositing the sliver structure in a liquid medium of sufficient density to provide a buoyancy force on the sliver structure.

4. The method of claim 3, further comprising formulating the orientation material to have a density of one of less than a density of the semiconductor material, substantially the same as a density of the semiconductor material and greater than a density of the semiconductor material.

5. The method of claim 3, further comprising formulating the orientation material to, in combination with the semiconductor material, have a density to cause the sliver structure to one of sink in the liquid medium and float in the liquid medium.

6. The method of claim 1, wherein applying the at least one directional force comprises generating one of a magnetic field and an electrical field, wherein the orientation material is a material reactive respectively to one of the magnetic field and the electrical field.

7. The method of claim 1, further comprising capturing a sliver structure oriented in the desired direction in a capture device to maintain the orientation of the sliver structure.

8. The method of claim 7, wherein the capture device is configured with a plurality of capture slots, and further comprising receiving a single sliver structure per capture slot of the plurality.

9. The method of claim 8, wherein the plurality of capture slots is configured in a predetermined spacing and pattern that corresponds to a preferential spacing pattern and further comprising receiving the sliver structure in a capture slots in the predetermined spacing and pattern.

10. The method of claim 7, further comprising transferring the captured sliver structures onto a support substrate and electrically coupling the sliver structures together.

11. The method of claim 1, further comprising removing the orientation material from the sliver structure.

12. The method of claim 11, wherein removing the orientation material comprises one of melting, volatilizing, and evaporating the orientation material.

13. A method of handling sliver structures, the method comprising:
forming a plurality of sliver structures in a bulk semiconductor substrate, each sliver structure having a first edge and a second edge opposite the first edge;
applying an orientation material to the first or second edge of each sliver structure to create an effective asymmetry about a transverse axis between the first edge and the second edge;
detaching the plurality of sliver structures from the bulk semiconductor substrate; and
applying a directional force to the plurality of sliver structures to orient the plurality of sliver structures in a common direction responsive to the effective asymmetry created by the orientation material.

14. The method of claim 13, further comprising capturing the plurality of sliver structures in a capture device to maintain the orientation of the plurality of sliver structures in the common direction.

15. The method of claim 13, wherein the effective asymmetry comprises at least one of a spatial asymmetry, a density asymmetry, and a buoyancy asymmetry.

16. The method of claim 13, further comprising removing the orientation material from each sliver structure.

17. The method of claim 13, further comprising removing a portion of the orientation material from each sliver structure.

18. A method of forming sliver structures, the method comprising:
forming a plurality of sliver structures in a substrate material; and
applying an orientation material to an edge of each sliver structure.

19. The method of claim 19, further comprising detaching the plurality of sliver structures from the substrate material.

20. The method of claim 19, further comprising removing the orientation material from each sliver structure after detachment thereof from the substrate material.

21. A sliver structure comprising:
a body comprising a semiconductor substrate material having a first edge and a second edge opposite the first edge; and
an orientation material located along at least a portion of an edge of the body.

22. The sliver structure of claim 21, further comprising a first conductive material disposed along the first edge and a second conductive material disposed along the second edge.

23. The sliver structure of claim 21, wherein the body has a thickness between opposing major faces thereof, of between about 0.03 and about 0.07 mm.

24. The sliver structure of claim 21, wherein the elongated body is configured as a photovoltaic device.

25. The sliver structure of claim 24, wherein the photovoltaic device is a bi-facial photovoltaic device.

26. The sliver structure of claim 21, wherein the orientation material comprises at least one of a polymer and a conductive material.
